(19) United States
(12) Patent Application Publication
(10) Pub. No.: US 2025/0322574 A1
(43) Pub. Date: Oct. 16, 2025

(54) SYSTEM AND METHOD TO GENERATING VIDEO BY TEXT

(71) Applicant: Idomoo LTD, Raanana (IL)

(72) Inventor: Danny KALISH, Raanana (IL)

(21) Appl. No.: 19/175,952

(22) Filed: Apr. 10, 2025

Related U.S. Application Data
(60) Provisional application No. 63/632,125, filed on Apr. 10, 2024.

(51) Int. Cl. G06T 11/60; G06F 40/134; G06F 40/186; G06F 40/221; G10L 13/033

(52) U.S. Cl. CPC G06T 11/60; G06F 40/134; G06F 40/186; G06F 40/221; G06T 2200/24; G10L 13/033

(57) ABSTRACT

The present invention discloses a method for generating a video from a website or presentation involves method includes several steps:
Exploring Website Pages, Content, Hyperlinks, and Media Objects:
The goal is to capture the essence of the website or presentation, ensuring that all relevant information is identified for inclusion in the video.
Creating a Script/Storyboard from Content Using an AI Model:
Utilizing an artificial intelligence model, a script or storyboard is generated based on the collected content.
Creating the Layout of Video Frames, Selecting Media Objects:
Creating an Interactive Layer in Frames with Hyperlinks to Web Pages:
To add interactivity to the video, an interactive layer is integrated into the frames, allowing viewers to interact directly with the content.

### BACKGROUND

### Technical Field

The present invention relates generally to automatic generation of video to based on website content.

### SUMMARY

The present invention provides a method for creating video from website implemented by one or more processors operatively coupled to a non-transitory computer readable storage device, on which are stored modules of instruction code that when executed cause the one or more processors to perform the steps of:
Exploring and collecting Website Pages, Content, Hyperlinks, and Media Objects:
Generating a script or storyboard Utilizing an artificial intelligence model based on the collected content.
Creating the Layout of Video Frames, determining design of the visual appearance of the content and Selecting Media Objects based on collected content;
Generating a video or video template based on the created script/storyboard, created layout of video frame and selected media.

According to some embodiments of the present invention the exploring website comprises a thorough examination of the website, navigating through various pages to understand the structure and hierarchy of the content, extract and classifying all elements, including text, images, videos, hyperlinks, and other media objects.

According to some embodiments of the present invention an AI model analyzes the text, context, and media elements to construct a coherent narrative that will guide the video's flow, wherein the storyboard outlines the sequence of scenes, including key messages, visual elements, and transitions that will be used in the video
wherein for each part of the scenario, as delineated in the script, the AI model determines several key elements layout style, context, content, the number of objects, types and properties of content objects, and the layout of video frames.

According to some embodiments of the present invention the design layout includes selecting and positioning media objects such as images, video clips, and animations within the frames to complement the narrative.

According to some embodiments of the present invention the video generating includes creating interactive layer of buttons, in frame with hyperlink to web pages of the sites, wherein these buttons are strategically placed over the video frames, designed to seamlessly integrate with the visual content, wherein each button serves as a clickable link that, when activated by the viewer, jumps to a different frame within the video itself.

According to some embodiments of the present invention video generating includes insertion of hyperlink buttons within the video frames, wherein these are intelligently placed within the video content, linking to associated video frames in other videos.

According to some embodiments of the present invention the method further comprising the step of: Based on the user's interactions and choices, a designated AI module creates learn the user's preferences concerning the website content and the selected video options, by analysIng the user's actions, selections, and modifications to the content over time, predicting and recommending content for the video creation that aligns with the user's tastes and preferences.

According to some embodiments of the present invention the video generation involves creating video based on image appearing in the website, based on the video tagging, generating motion which is based on the image tagging, wherein tagging image appearing in the website based on image analysis, understanding the scene of the image and based on text appearing in the website, related to the image.

According to some embodiments of the present invention the video generation include voiceover generation: using text-to-speech technology, applying appropriate narrators and voice emotions to align with the video's tone. The present invention provides A system for creating video from website said system implemented by one or more processors operatively coupled to a non-transitory computer readable storage device, on which comprised the modules:
Website Analysis configured to parse Website Pages, Content, Hyperlinks, and Media Objects:
video/video template generator module configured to generate a script or storyboard Utilizing an artificial intelligence model based on the collected content, Creating the Layout of Video Frames, determining design of the visual appearance of the content and Selecting Media Objects based on collected content and generating a video or video template based on the created script/storyboard, created layout of video frame and selected media.

### BRIEF DESCRIPTION OF THE SCHEMATICS

The present invention will be more readily understood from the detailed description of embodiments thereof made in conjunction with the accompanying drawings of which:

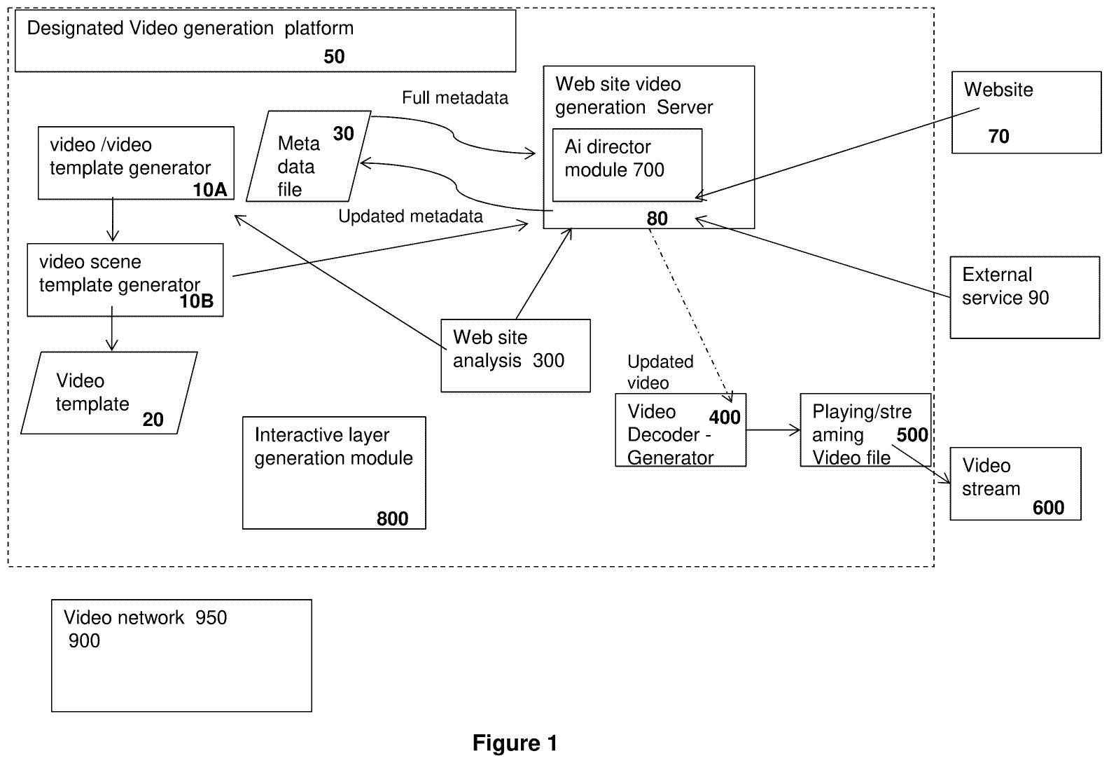

FIG. 1 is a block diagram, depicting the components and the environment of the video generation platform, according to some embodiments of the invention.

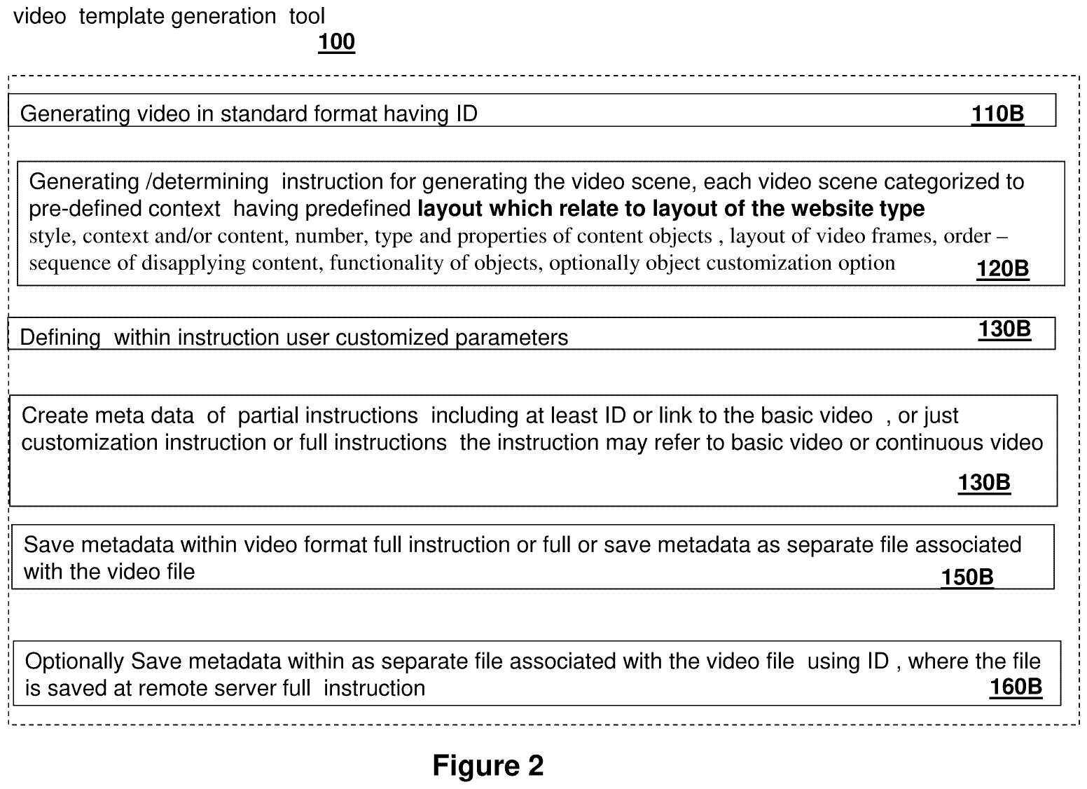

FIG. 2 is a flowchart depicting the video template generation module, according to some embodiments of the invention.

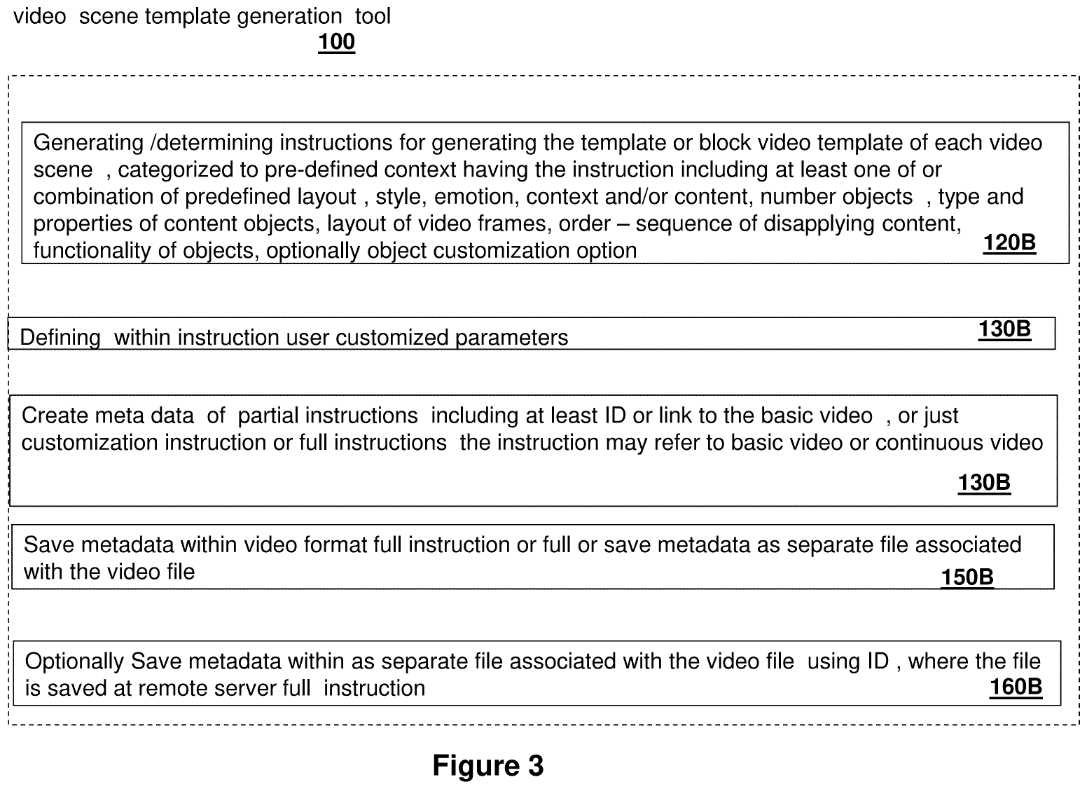

FIG. 3 is a flowchart depicting the video scene template generation module, according to some embodiments of the invention.

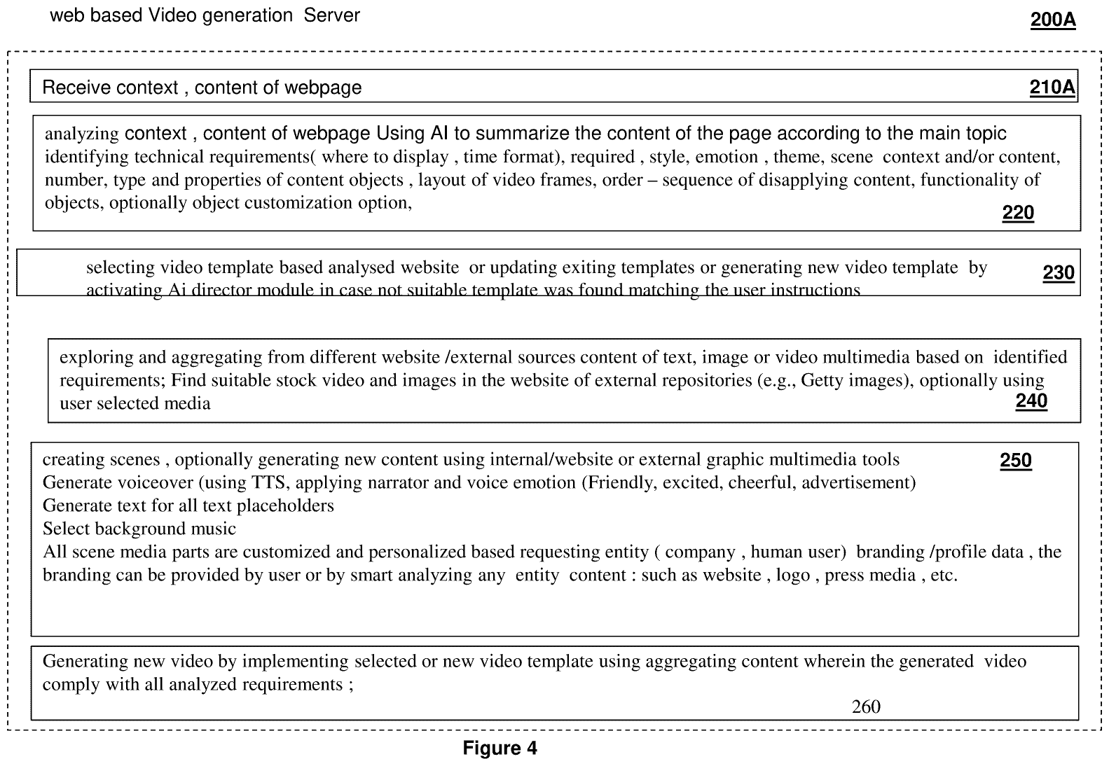

FIG. 4 is a flowchart depicting web-based Video generation Server according to some embodiments of the invention.

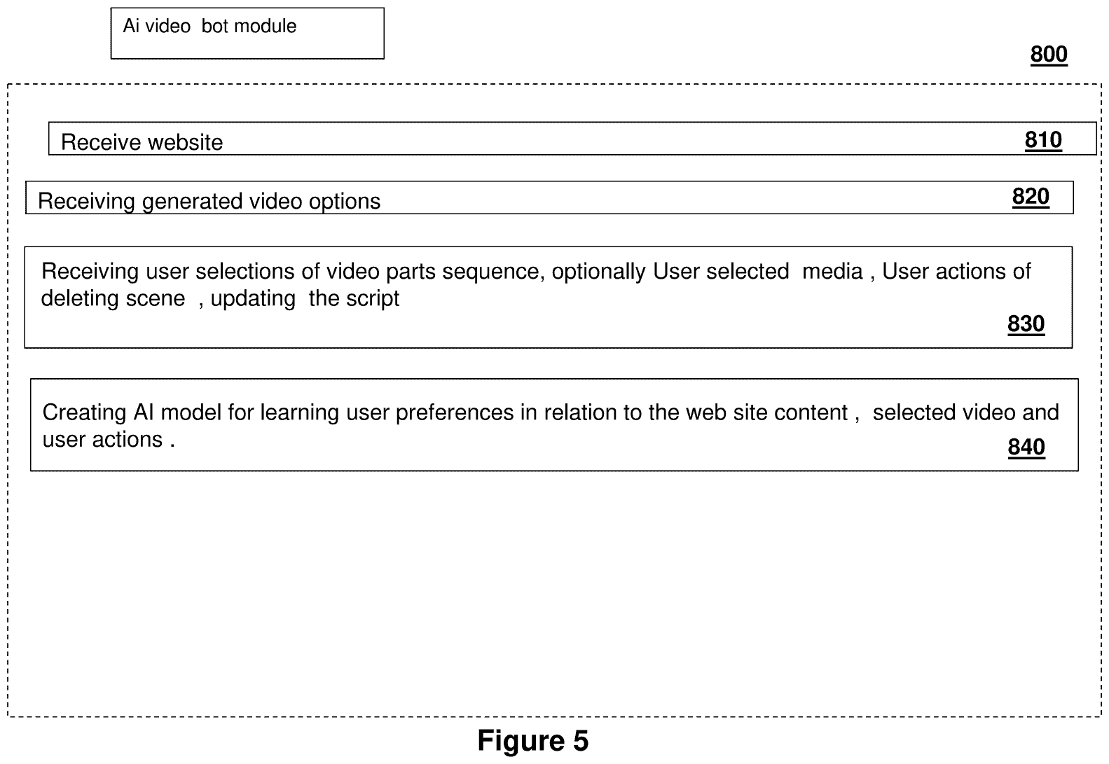

FIG. 5 presents a flowchart of the Ai video bot module, according to some embodiments of the invention.

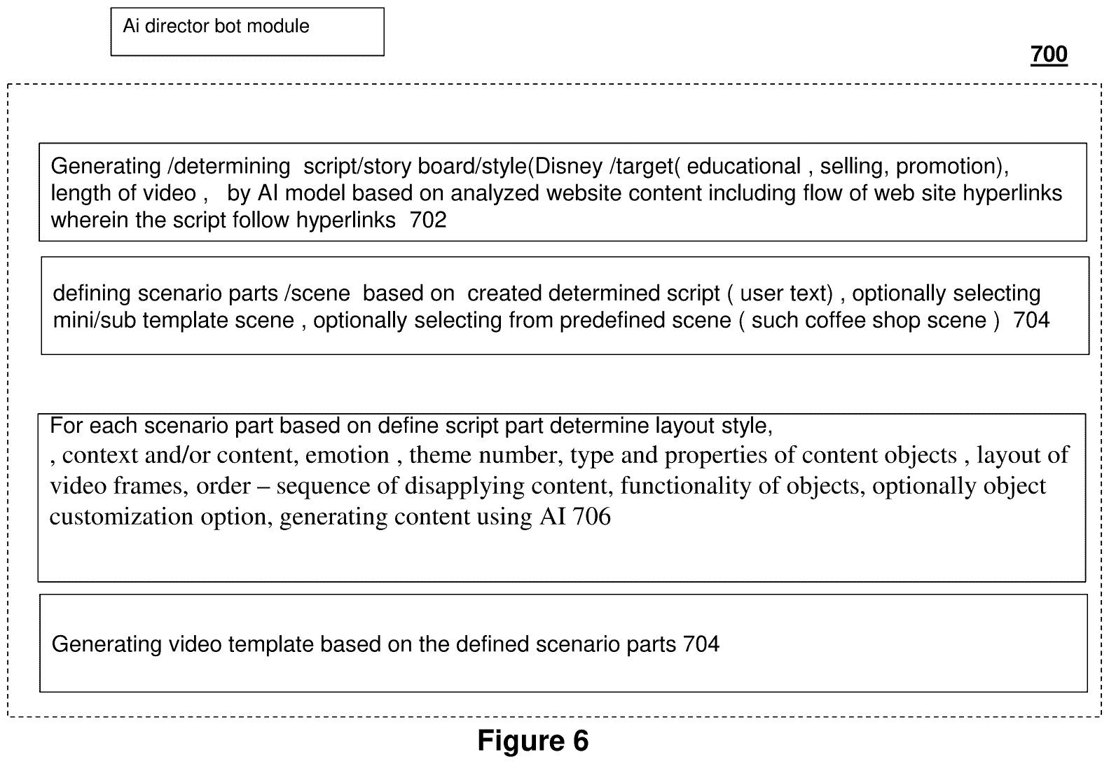

FIG. 6 presents a flowchart of the Ai director bot module, according to some embodiments of the invention.

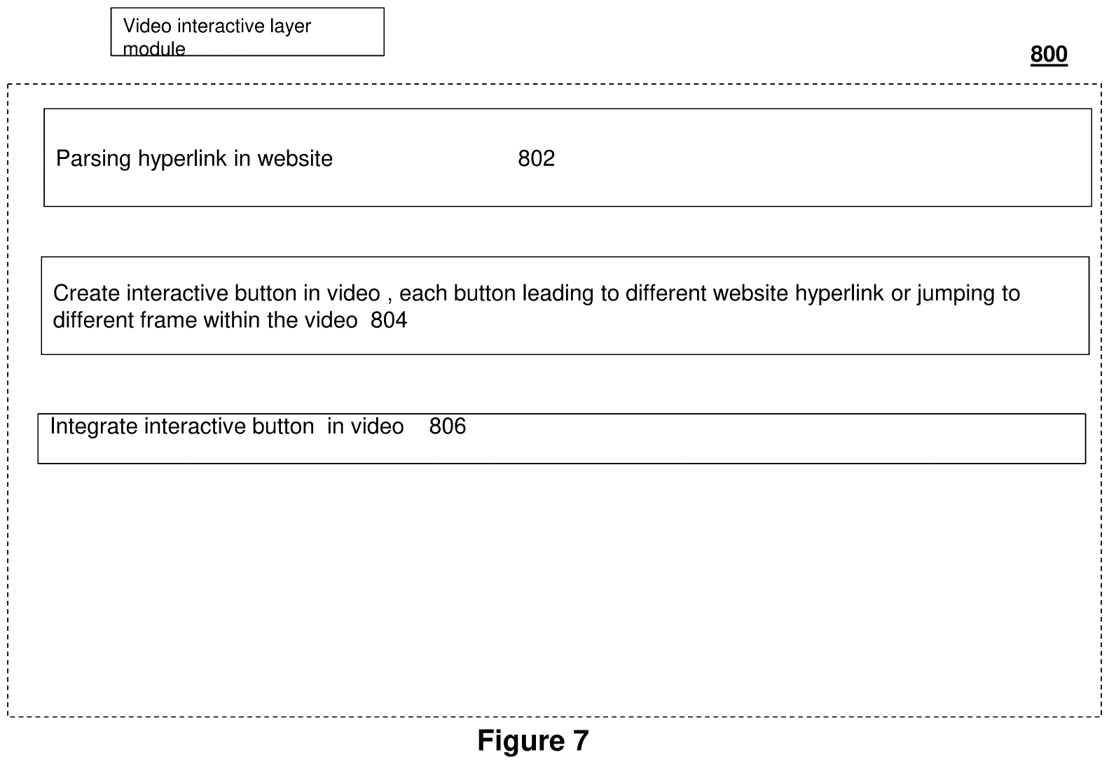

FIG. 7 presents a flowchart of the Video interactive layer module, according to some embodiments of the invention.

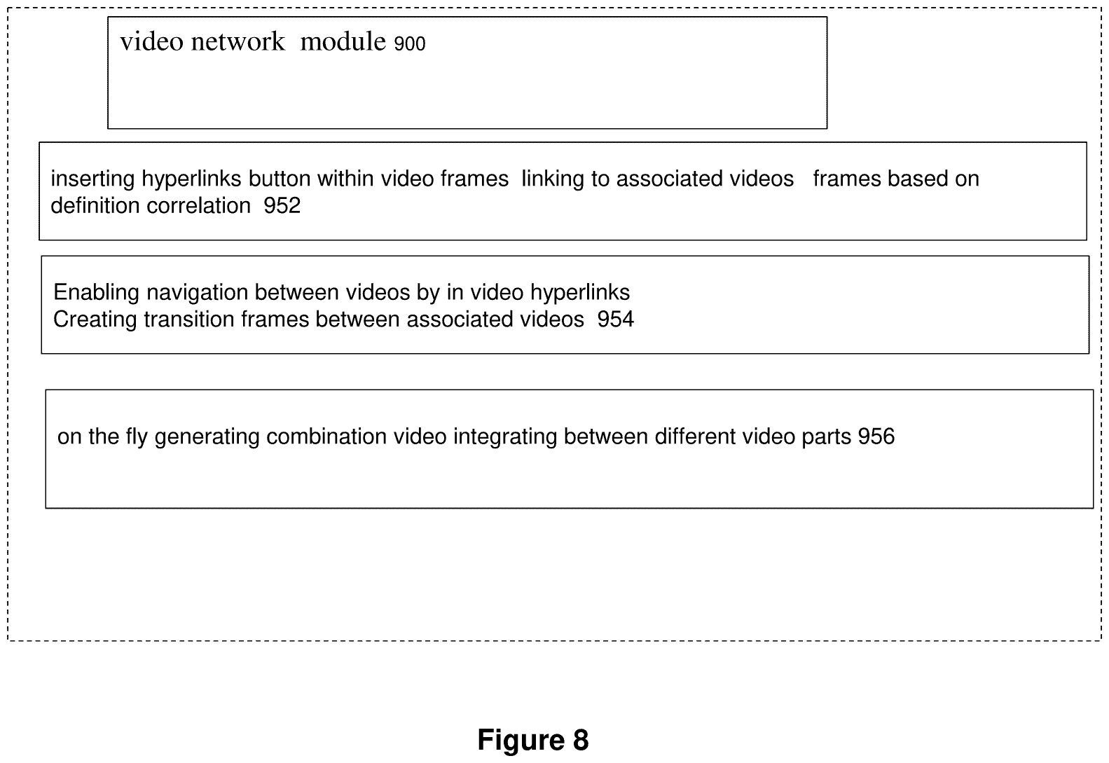

FIG. 8 presents a flowchart of the video network module, according to some embodiments of the invention.

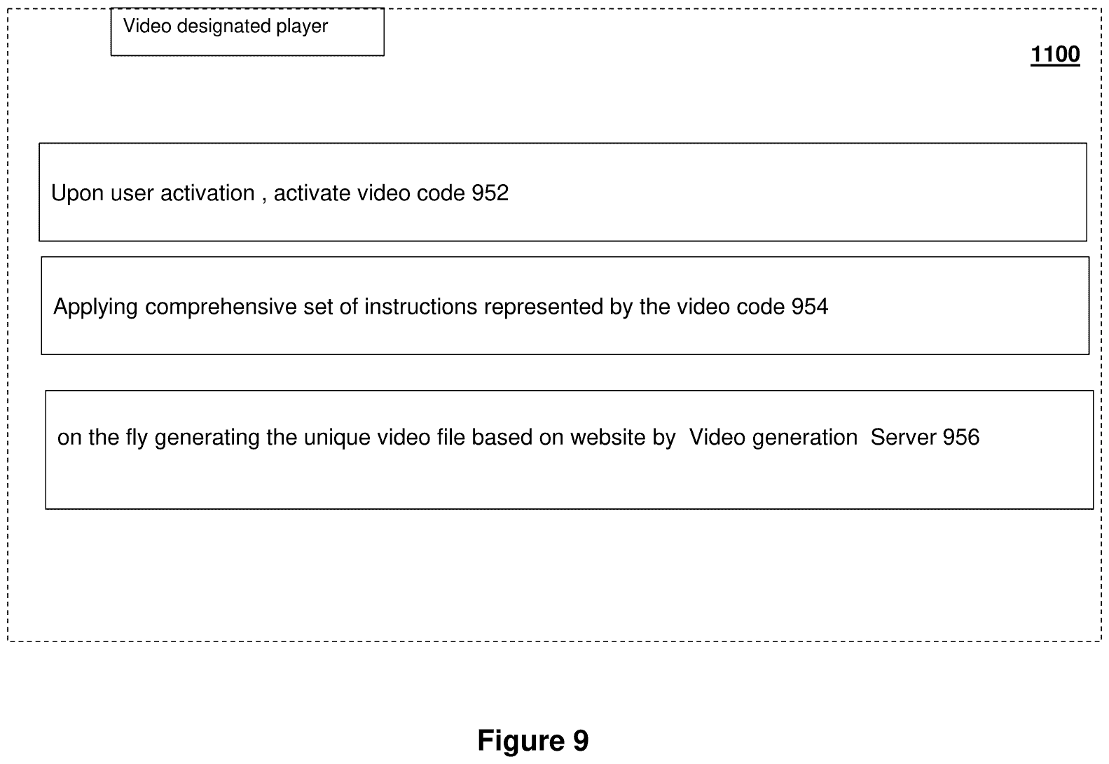

FIG. 9 presents a flowchart of the video player, according to some embodiments of the invention

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention discloses a method for generating a video from a website or presentation involves a comprehensive process that transforms static web content into dynamic video format. This method includes several key steps, detailed as follows:

### 1. Exploring Website Pages, Content, Hyperlinks, and Media Objects

This initial step involves a thorough examination of the website or presentation to be converted into video format. It entails navigating through various pages to understand the structure and hierarchy of the content. During this phase, all elements, including text, images, videos, hyperlinks, and other media objects, are cataloged. The goal is to capture the essence of the website or presentation, ensuring that all relevant information is identified for inclusion in the video.

### 2. Creating a Script/Storyboard from Content Using an AI Model

Utilizing an artificial intelligence model, a script or storyboard is generated based on the collected content. This AI model analyzes the text, context, and media elements to construct a coherent narrative that will guide the video's flow. The storyboard outlines the sequence of scenes, including key messages, visual elements, and transitions that will be used in the video, ensuring that the final product is engaging and informative.

### 3. Creating the Layout of Video Frames, Selecting Media Objects

In this step, the layout for each video frame is designed, determining how the content will be visually presented. This includes selecting and positioning media objects such as images, video clips, and animations within the frames to complement the narrative. The layout design is crucial for maintaining viewer engagement and ensuring that the video effectively communicates the website or presentation's content.

### 4. Generating a Video or Video Template Based on the Created Script/Storyboard, Created Layout of Video Frame and Selected Media Object

### 5. Creating an Interactive Layer in Frames with Hyperlinks to Web Pages

To add interactivity to the video, an interactive layer is integrated into the frames, allowing viewers to interact directly with the content. This layer includes hyperlinks that connect back to the original web pages or specific sections of the website. This feature not only enhances the viewer's experience by providing direct access to additional resources and information but also helps in maintaining the connectivity between the video content and the original website or presentation.

By following these steps, the method transforms static website or presentation content into an interactive and engaging video format, offering viewers a dynamic and enriched experience of the original material. This process leverages the latest in AI technology to ensure that the video is not only visually appealing but also informative and true to the source content.

FIG. 1 is a block diagram, depicting the components and the environment of the video generation platform 50, according to some embodiments of the invention. The Designated Video generation platform 50 is comprised of: a Web site analysis 300 configured to analyze websites, video/video template generator, 10A, video scene template generator 10B, for selection and customized data for generating relevant video parts based on pre-defined video templates or by using AI director module 700 to generate new video implemented on video generation server. The platform further comprises Video Decoder Generator 400, Playing/streaming Video file, 500 for creating video stream 600.

According to some embodiments of the present invention is suggested Interactive layer generation module 800 configured for inserting hyperlinks in the video

FIG. 2 is a flowchart depicting the video template generation module, according to some embodiments of the invention.

The Video Template Generation Module is a sophisticated component designed for creating and managing video templates. It incorporates a series of steps, each contributing to the generation and customization of video templates.

Video Generation (110A): The module begins by generating a basic version of the video in a standard format. Each basic video is assigned a unique identification number (ID), facilitating easy tracking and reference, 110A;

Generating/determining instruction for generating the template video, each video categorized to pre-defined context.

Instruction Generation/Determination (120): In this step, the module generates or determines instructions for creating template video. Each video is categorized into predefined contexts, ensuring relevance and appropriateness. These instructions encompass various aspects, such as predefined layouts, styles, emotional tones, contexts and content, the number of objects, types and properties of content objects, layouts of video frames, sequences of content display, object functionalities, and options for object customization; 120.

Defining within instruction scripts customized to defined scenarios related to the predefined context.

Script Definition for Scenarios (130A): Within these instructions, the module defines scripts that are customized to specific scenarios related to the predefined context. This step ensures that the video content is not only technically sound but also contextually relevant and engaging 130A;

Customized Parameter Definition: The module allows for the definition of user-customized parameters within the instructions. This customization ensures that the final video product aligns closely with the user's specific requirements and preferences.

Metadata Creation (140A): The module creates metadata for partial instructions, which includes at least the ID or a link to the basic video. It may also include customization instructions or full instructions. This metadata serves as a reference point, linking the instructions to either the template videos;

Metadata Storage (150A): The generated metadata is either saved within the full instruction set of the video format or stored as a separate file associated with the video file. This organization ensures easy retrieval and management of the metadata 150A;

Remote Storage Option (160A): Optionally, the metadata can be stored as a separate file on a remote server, associated with the video file using its ID. This option provides additional flexibility and security for storing and accessing video-related data160A.

FIG. 3 is a flowchart depicting the video scene template generation tool, according to some embodiments of the invention.

The video template generation module applies at least one of the followings steps:

Generating/determining instruction for generating the video scene, each video scene categorized to pre-defined context having predefined layout which relate to layout of the website type, style, context and/or content, number, type and properties of content objects, layout of video frames, order-sequence of disapplying content, functionality of objects, optionally object customization option, 120B.

Defining within instruction user customized parameters 130B;

Create meta data of partial instructions including at least ID or link to the basic video, or just customization instruction or full instructions the instruction may refer to template video;

Save metadata within video format full instruction or full or save metadata as separate file associated with the video file 150B;

Optionally Save metadata within as separate file associated with the video file using ID, where the file is saved at remote server full instruction 160B.

FIG. 4 is a flowchart depicting video generating by website server module according to some embodiments of the invention.

The website Server Module operates through a series of steps, each contributing to the video generation process:

Web content Reception (210):
Exploring Website Pages, Content, Hyperlinks, and Media Objects:
This initial step involves a thorough examination of the website or presentation to be converted into video format. It entails navigating through various pages to understand the structure and hierarchy of the content. During this phase, all elements, including text, images, videos, hyperlinks, and other media objects, are cataloged. The goal is to capture the essence of the website, ensuring that all relevant information is identified for inclusion in the video.

The module analyzes web site context and content for generating a video, along with entity/user data and profiles and optionally video length. This information forms the basis of the video creation process;

Website Analysis (220): The module analyzes content of webpage, focusing on identifying various technical and creative requirements. These include displayed specifications, time formats, video length, desired style, emotional tone, thematic elements, context and content, types and properties of content objects, 220;
analyzing context, content of webpage Using AI to summarize the content of the page according to the main topic identifying technical requirements (where to display, time format), required, style, emotion, theme, scene context and/or content, number, type and properties of content objects, layout of video frames, order-sequence of disapplying content, functionality of objects, optionally object customization option,

Template Selection and Customization (230): Based on the analyzed website content and identified technical and creative requirements of layout of video frames, sequence of content display, object functionality, and options for object customization the module selects an appropriate video template or a combination of video scene templates. If existing templates are unsuitable, it updates them or generates new ones by activating the AI Director Module. This ensures a close match with the entity/user's instructions 230;

Content Aggregation (240): This step involves exploring and aggregating content from various internal and external sources and relevant websites. The content, which may include text, images, or video multimedia, is selected based on the identified requirements technical and creative from the previous analysis 240;

Scene Creation and Content Generation: The module proceeds to create scenes, optionally using internal or external graphic multimedia tools to generate new content. This step ensures the video content is dynamic and engaging.

Voiceover Generation: A voiceover is generated using text-to-speech technology. The module applies appropriate narrators and voice emotions (e.g., friendly, excited, cheerful, advertisement style) to align with the video's tone. The voiceover is generated using TTS, applying narrator and voice emotion (Friendly, excited, cheerful, advertisement)

Text Placeholder Filling: The module generates text for all text placeholders in the video, ensuring consistency and relevance to the video's content.

Background Music Selection: Selecting suitable background music to complement the video's mood and enhance the viewer's experience.

Customization and Personalization (250): All scene media parts are customized and personalized based on the branding/profile data of the requesting entity (company or individual user). Branding elements can be provided by the user or determined through smart analysis of entity-related content, such as websites, logos, press media, etc. 250.
creating scenes, optionally generating new content using internal/website or external graphic multimedia tools (using content appearing in the web inspired by image videos appearing in the web site, providing related or enhanced content, generating video picture understanding scene, creating video, replacing object

Generate text for all text placeholders

### Select Background Music

All scene media parts are customized and personalized based requesting entity (company, human user) branding/profile data, the branding can be provided by user or by smart analyzing any entity content: such as website, logo, press media, etc.

According to some embodiments of the present invention the defined length affects at least one of the following: Scene Creation and Content Generation, Template Selection, the selection of subjects based on priority, the generation of the script, the selection of media objects and/or the focus in each subject and selection content and media objects for each subject to meet the time limit.

Final Video Generation (260): The module generates the new video by implementing the selected template(s) or a newly created video template. The final video is tailored to comply with all analyzed technical and creative requirements, ensuring a product that meets the specific needs and preferences of the entity or user 260.

FIG. 5 presents a flowchart of the Ai video bot module, according to some embodiments of the invention.

The AI bot module operates through a series of steps designed to enhance user experience by tailoring content according to individual preferences:
1. Content Acquisition (810): The module begins by receiving website content, which serves as the primary data source for further processing. This step involves fetching textual, visual, and multimedia content from specified websites, providing a comprehensive database for the AI to analyse.
   Tagging image appearing in the website based on image analysis, understanding the scene of the image and based on text appearing in the website, related to the image.
2. Video Generation Options (820): Next, the module processes the acquired data to generate video options. This involves using AI algorithms to create varied video segments that represent the content in dynamic, visual formats. These generated videos are then presented to the user as selectable options, allowing for a more interactive and engaging experience.
   The video generation involves creating video based on image appearing in the website, based on the video tagging, generating motion which is based n the on the image tagging.
   The video generation is learning, website style, and implement website style into the video
   In case missing image, new image are generated based on the video style such as colours.
3. User Interaction and Customization (830): At this stage, the user interacts with the generated content by selecting specific sequences of video parts. The user can also engage in customizing the content by selecting media, deleting scenes, or updating the script. This step is crucial for capturing user preferences and providing a personalized experience.
4. Preference Modelling (840): Based on the user's interactions and choices, the AI module creates a model to learn the user's preferences concerning the website content and the selected video options. This model continuously evolves through machine learning algorithms, which analyse the user's actions, selections, and modifications to the content. Over time, the AI becomes more adept at predicting and recommending content for the video creation that aligns with the user's tastes and preferences.
By employing these steps, the AI bot module not only facilitates a tailored content viewing experience but also enhances user engagement by allowing active participation in content creation and customization. This process exemplifies the integration of AI in content management systems, where machine learning algorithms play a pivotal role in understanding and adapting to user preferences, thereby creating a more personalized and interactive digital experience.

FIG. 6 presents a flowchart of the Ai director bot module, according to some embodiments of the invention.

The Ai director bot module apply at least one of the followings steps:

Script/Storyboard/Style Generation: The module employs an external AI model (reference number 702) to generate or determine the script, storyboard, and visual style. This process is inherently adaptive, considering factors such as Disney-inspired styles, target markets (e.g., educational, sales, promotional), and the desired length of the video. The AI model derives this information from website content, ensuring tailored output that aligns with the user's vision 702;

Scenario and Scene Definition: Based on the script derived from user input, the module (reference number 704) defines specific scenario parts or scenes. It selects block or sub-template scenes, with the option to choose from pre-defined scenes like a coffee shop setting. This step ensures each scene aligns cohesively with the overall script 704;

Scenario Part Customization: For each part of the scenario, as delineated in the script, the module (reference number 706) determines several key elements. These include the layout style, context, content, the number of objects, types and properties of content objects, and the layout of video frames. It also establishes the sequence for displaying content, the functionality of objects, and provides options for object customization. This is achieved using AI-driven processes, ensuring a rich and dynamic video composition 706;

Content and Media Object Selection: In this step, the module (reference number 708) determines the appropriate tool service for selecting or generating content and media objects. It involves determining keywords at various levels of abstraction related to the script, finding relevant media, and deriving keywords by association to the context, concepts, or ideas of the script. This may include applying cognitive processes or considering emotional states. The module can also search in a database using user-defined descriptions or analyses of the video. This facilitates the generation of new video content or the editing of pre-made videos, such as cutting relevant parts or changing properties to better suit the script.

Generating video template based on the defined scenario parts 704

According to some embodiments of the present invention the defined length affects at least one of the following: the selection of subjects based on priority, the generation of the script, the selection of media objects and/or the focus in each subject and selection content and media objects for each subject to meet the time limit.

The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may wherever suitably operate on signals representative of physical objects or substances.

FIG. 7 illustrates the flowchart for the Video Interactive Layer Module, showcasing its functionality in enhancing videos with interactive elements. This module integrates hyperlinks into the video content, providing a dynamic viewer experience. Here's an elaboration of the process steps outlined in the document:

### 1. Parsing Hyperlink in Website (Step 802)

The process begins with the parsing of hyperlinks embedded within the website content. This step involves systematically analyzing the website to identify and extract hyperlinks. Each hyperlink's destination, whether it leads to an external webpage or a specific section within the same site, is cataloged. The purpose of this parsing activity is to gather all possible interactive elements that can be incorporated into the video, ensuring a comprehensive interactive layer that reflects the original web content's connectivity.

### 2. Creating Interactive Buttons in Video (Step 804)

For each identified hyperlink, an interactive button is created within the video. These buttons are strategically placed over the video frames, designed to seamlessly integrate with the visual content. Each button serves as a clickable link that, when activated by the viewer, either redirects to the designated website hyperlink or jumps to a different frame within the video itself. This step is crucial for transforming the passive video watching experience into an interactive one, allowing viewers to explore additional information or navigate through the video content dynamically.

### 3. Integrating Interactive Buttons (Step 806)

The final step involves the integration of these interactive buttons into the video. This process includes embedding the buttons into the video's interactive layer, ensuring they are functional and aesthetically aligned with the video's design. The integration is done meticulously to maintain the video's flow and visual coherence, ensuring that the interactive elements enhance rather than disrupt the viewing experience.

Through these steps, the Video Interactive Layer Module effectively transforms traditional video content into an interactive multimedia experience, allowing viewers to engage with the content more deeply. The module's ability to integrate web-based hyperlinks into the video not only enriches the viewer's experience but also extends the reach and utility of the video content by linking directly to additional resources and information.

FIG. 8 illustrates the flowchart for the Video Network Module, as outlined in certain embodiments of the invention. This module is designed to enhance the interconnectivity between different video contents through a network of hyperlinks, allowing for a more integrated and dynamic viewing experience. Here's an expanded explanation of the steps involved:
Inserting Hyperlinks Within Video Frames (Step 952):
The process starts with the insertion of hyperlink buttons within the video frames. These buttons are not just ordinary links; they are intelligently placed within the video content, linking to associated video frames in other videos. The association between video frames is determined based on a defined correlation, which could be thematic, narrative, or subject-based. This means that the hyperlinks connect the viewer to other video frames that are contextually or conceptually related, enhancing the informational depth and engagement of the video content.
enabling Navigation Between Videos (Step 954):
Navigation between connected videos is facilitated through the embedded in-video hyperlinks. Additionally, to ensure a seamless viewing experience, transition frames are created between the associated videos. These transition frames serve as a bridge, providing a smooth and logical progression from one video to another. This feature not only enhances the viewer's navigational experience but also maintains the narrative flow, making the interconnected video content more coherent and engaging.

### On-the-Fly Generation of Combination Video (Step 0956)

The module is capable of generating a combination video on the fly, integrating different parts from various interconnected videos. This step involves dynamically stitching together relevant video segments based on the viewer's navigation path and choices made through the interactive hyperlinks. The result is a customized and continuous video stream that reflects the viewer's interests and interactions, providing a unique and personalized viewing journey.

The Video Network Module, as depicted in FIG. 7, significantly enhances the interactive and engaging nature of video content. By intelligently linking related video frames and enabling smooth navigation between them, the module provides a more enriched and exploratory viewing experience. The ability to generate combination videos on the fly further adds to the dynamic and responsive nature of this video networking approach, catering to the diverse and evolving interests of viewers.

FIG. 9 presents a flowchart of the video player, according to some embodiments of the invention.

Upon user activation, activate video code 952;
Applying comprehensive set of instructions represented by the video code 954;
on the fly generating the unique video file based on website by Video generation Server 956;

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g., digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for creating video from website implemented by one or more processors operatively coupled to a non-transitory computer readable storage device, on which are stored modules of instruction code that when executed cause the one or more processors to perform the steps of:
Exploring and collecting Website Pages, Content, Hyperlinks, and Media Objects:
Generating a script or storyboard Utilizing an artificial intelligence model based on the collected content.
Creating the Layout of Video Frames, determining design of the visual appearance of the content and Selecting Media Objects based on collected content;
Generating a video or video template based on the created script/storyboard, created layout of video frame and selected media.

2. The method of claim 1, wherein the exploring website comprises a thorough examination of the website, navigating through various pages to understand the structure and hierarchy of the content, extract and classifying all elements, including text, images, videos, hyperlinks, and other media objects.

3. The method of claim 1, wherein an AI model analyzes the text, context, and media elements to construct a coherent narrative that will guide the video's flow, wherein the storyboard outlines the sequence of scenes, including key messages, visual elements, and transitions that will be used in the video wherein for each part of the scenario, as delineated in the script, the AI model determines several key elements layout style, context, content, the number of objects, types and properties of content objects, and the layout of video frames.

4. The method of claim 1, wherein the design layout includes selecting and positioning media objects such as images, video clips, and animations within the frames to complement the narrative.

5. The method of claim 1 wherein the video generating includes creating interactive layer of buttons, in frame with hyperlink to web pages of the sites, wherein these buttons are strategically placed over the video frames, designed to seamlessly integrate with the visual content, wherein each button serves as a clickable link that, when activated by the viewer, jumps to a different frame within the video itself.

6. The method of claim 1 wherein the video generating includes insertion of hyperlink buttons within the video frames, wherein these are intelligently placed within the video content, linking to associated video frames in other videos.

7. The method of claim 1 further comprising the step of: Based on the user's interactions and choices, a designated AI module creates learn the user's preferences concerning the website content and the selected video options, by analysIng the user's actions, selections, and modifications to the content over time, predicting and recommending content for the video creation that aligns with the user's tastes and preferences.

8. The method of claim 1 wherein the video generation involves creating video based on image appearing in the website, based on the video tagging, generating motion which is based on the image tagging, wherein tagging image appearing in the website based on image analysis, understanding the scene of the image and based on text appearing in the website, related to the image.

9. The method of claim 1 wherein the video generation include voiceover generation: using text-to-speech technology, applying appropriate narrators and voice emotions to align with the video's tone.

10. A system for creating video from website said system implemented by one or more processors operatively coupled to a non-transitory computer readable storage device, on which comprised the modules:
Website Analysis configured to parse Website Pages, Content, Hyperlinks, and Media Objects:
video/video template generator module configured to generate a script or storyboard Utilizing an artificial intelligence model based on the collected content, Creating the Layout of Video Frames, determining design of the visual appearance of the content and Selecting Media Objects based on collected content and generating a video or video template based on the created script/storyboard, created layout of video frame and selected media.

11. The system of claim 10, wherein the exploring website comprises a thorough examination of the website, navigating through various pages to understand the structure and hierarchy of the content, extracting and classifying all elements, including text, images, videos, hyperlinks, and other media objects.

12. The system of claim 1, wherein an AI model analyzes the text, context, and media elements to construct a coherent narrative that will guide the video's flow, wherein the storyboard outlines the sequence of scenes, including key messages, visual elements, and transitions that will be used in the video wherein for each part of the scenario, as delineated in the script, the AI model determines several key elements layout style, context, content, the number of objects, types and properties of content objects, and the layout of video frames.

13. The system of claim 10, wherein the design layout includes selecting and positioning media objects such as images, video clips, and animations within the frames to complement the narrative.

14. The system of claim 10 wherein the video generating includes creating interactive layer of buttons, in frame with hyperlink to web pages of the sites, wherein these buttons are strategically placed over the video frames, designed to seamlessly integrate with the visual content, wherein each button serves as a clickable link that, when activated by the viewer, jumps to a different frame within the video itself.

15. The system of claim 10 wherein the video generating includes insertion of hyperlink buttons within the video frames, wherein these are intelligently placed within the video content, linking to associated video frames in other videos.

16. The system of claim 10 wherein the video generation further comprising the step of: based on the user's interactions and choices, a designated AI module creates a model to learn the user's preferences concerning the website content and the selected video options, by analysing the user's actions, selections, and modifications to the content over time, predicting and recommending content for the video creation that aligns with the user's tastes and preferences.

17. The system of claim 10 wherein the video generation involves creating video based on image appearing in the website, based on the video tagging, generating motion which is based n the on the image tagging, wherein tagging image appearing in the website based on image analysis, understanding the scene of the image and based on text appearing in the website, related to the image.

18. The method of claim 10 wherein the video generation include voiceover generation: using text-to-speech technology, applying appropriate narrators and voice emotions to align with the video's tone.
